(19) United States
(12) Patent Application Publication
(10) Pub. No.: US 2006/0231056 A1
(43) Pub. Date: Oct. 19, 2006

(54) Internal Combustion Engine

(76) Inventor: Viktor Loktaevski, Tallinn (EE)

Correspondence Address: BRUCE E. LILLING;LILLING & LILLING P.C., P.O. BOX 560, GOLDEN BRIDGE, NY, 10526, US

(21) Appl. No.: 10/332,188

(22) PCT Filed: Jul. 5, 2001
(86) PCT No.: PCT/EE01/00005

§ 371 Date: Jan. 23, 2006

(30) Foreign Application Priority Data
Jul. 7, 2000 (EE) U 200000024

(51) Int. Cl. F02N 3/00

(52) U.S. Cl. 123/188.5; 123/188.4

(57) ABSTRACT

The invention relates to internal combustion engines, more exactly reciprocating piston engines and it may be utilized for example both in V-engines and one-row single-cylinder or two-cylinder engines. The internal combustion engine is comprised of block head housing (1), at least one cylinder (2), piston (3), ignition plug (8), combustion chamber (5) sleeves (6) of gas distribution mechanism, intake and exhaust channels (7, 13) whereas the intake channel (7) and the exhaust channel (13) are connected with the corresponding sleeve (6) of the gas distribution mechanism, the gas distribution mechanism sleeves (6) are positioned at an equal angle of the axis of the cylinder and on the same plane the mentioned plane being at a 40-50° angle of the axis of the cylinder (2).

The invention relates to internal combustion engines, more exactly slide valve engines and it may be utilized for example both in V-engines and one-row single-cylinder or two-cylinder engines.

Piston engines used in airplanes are known form prior art, with the block and the head being a monolithic construction, since a gasket would crack in the event of overheating. All these engines have been built with valves and they pollute the environment due to incomplete combustion of fuel. Examples of such engines are the AM38 of IL-2, AM105 of JAK and AM100 of MIG. Internal combustion engines where valves are used in gas distribution mechanism, fuel injection in order to reduce fuel consumption, and where the intake channels and the exhaust ejection channels are positioned at a 20-30° (preferably 25°) angle of the axis of the cylinder, have been described in the international patent application PCT/SE99/00827. The primary aim of the brought solution is to minimize fuel consumption and therefore to achieve a combustible fuel mix primarily in the vicinity of the ignition plug by the means of creating two vortexes. In order to create suitable vortexes there is a recess at the injection jet end, and a slanted mound at the opposite end with top almost on the same line with the axis of the cylinder. The drawback of this solution in comparison with the aims of the present invention is the summation of the two different vortexes only during the compression phase After the combustion phase the exhaust of the burnt fuel mix from the cylinder will not form an even vortex because of the recess and the mound at end surface of the piston head, and therefore part of the exhaust fumes will remain in the cylinder during the next operation cycle. In order to facilitate the ejection of exhaust fumes from the cylinder it is necessary to maintain the vortex movement of the gases also during the operation combustion phase and the exhaust phase.

The classical valve system has a potential for over-consuming resources. 37% of the fuel will be ejected together with the exhaust fumes and 3% will be mixed with un-ejected processed gas. This will dilute the fresh fuel mix, there will be over-consumption of fuel and the performance of the engine will drop. In a valve engine a persistent dynamic “gas cap” is formed under the valve hindering the introduction of fresh fuel mix and causing loss of fuel. The more valves are used, the bigger is the loss of fuel.

Also a slide valve internal combustion engine, mentioned also as valveless engine is known from EP-0773352-A1 that is comprised by block head housing, at least one cylinder, piston, ignition plug, combustion chamber, intake and exhaust channel, the intakes and exhaust channel have been connected with a corresponding sleeve of gas distribution mechanism whereas the sleeves of the gas distribution mechanism are located at equal angels to the axis of the cylinder and on the same plane. The drawback of the mentioned engine with piston distribution mechanism is as well over-consumption of fuel that is caused by the V-shaped positioning of the intake channels causing uneven creation of fuel mix and slow formation of fuel mix, since the projection of the intake channel on the side surface of the cylinder is located below the connection of the cylinder and the block head, the fuel mix enters the cylinder so that a vortex to guarantee fast and even blending of fuel mix and air is not created. An analogical process takes place during the exhaust stroke and the burnt exhaust fumes exit the cylinder as an uneven vortex and therefore with insufficient speed.

The aim of the invention is to increase the productiveness of the engine by more economical usage of fuel. This will also facilitate decrease of environmental pollution.

In order to reach this aim the plane, where the sleeves of gas distribution pistons are positioned, has been set at 40-50° angle of the axis of the cylinder.

Thanks to the circumstance that the sleeves of the gas distribution mechanism intake channel and exhaust channel are positioned on the same plane that has been set at a 40-50° angle of the axis of the cylinder the fuel mix will enter the cylinder through the intake channel and the sleeve of the gas distribution mechanism, fluidly collides with the cylinder wall and both obtains spiral motion and heats burning up completely in a shorter period of time and there is no necessity of dosing oxygen into the exhaust collector to ensure full combustion of exhaust fumes. When the angle is less than 40° then the fuel mix will slide directly down the cylinder side surface and the vortex is not created. When, the angle is bigger than 50° then a vortex of sufficient speed is created but the cylinder will not be filled with sufficient speed. In an analogical manner the exhaust fumes will exit during the exhaust stroke in a vortex form and therefore faster.

The construction of the engine and its working principles are described in more detail in the following sample embodiment with the aid of figures.

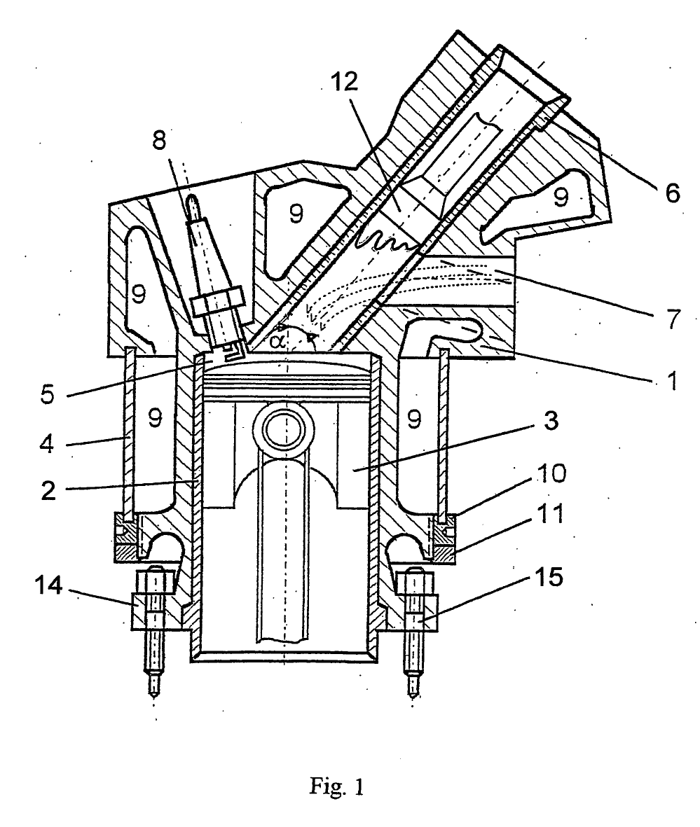

FIG. 1 illustrates the block head housing removed from the crankcase with the piston.

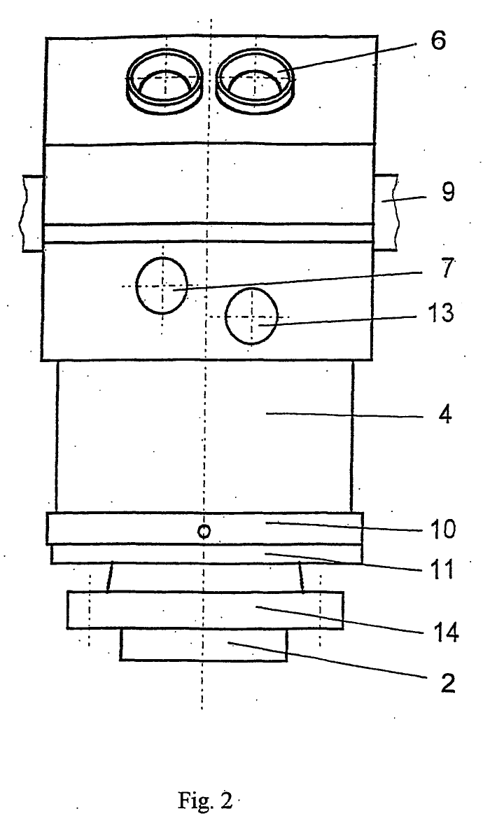

FIG. 2 illustrates the block head housing from the side of the intake channel.

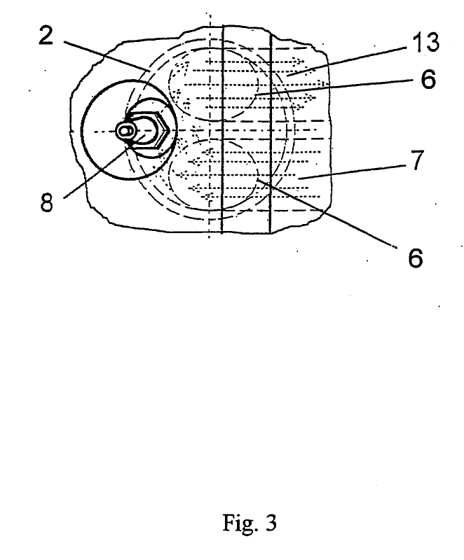

FIG. 3 is the top view of the block head.

The internal combustion engine is comprised of block head housing 1, cylinder 2 of which sleeve is seen, piston 3, cooling jacket 4, combustion chamber 5, sleeve 6 of gas distribution mechanism, intake channel 7, plug 8, channels of cooling mix 9, fixation nut of the cooling jacket 10 and check-nut 11, piston valve 12, exhaust channel 13, mounting flange 14 of the block and stud bolt 15 that fastens the block head to the crankcase. On FIG. 2 the block head is depicted from the side of the intake channel and the cylinder sleeve 2, case of the cooling jacket 4, apertures of the intake channel 7 and exhaust channel 13 are seen, as well as the relative positioning of the sleeves 6 of the gas distribution mechanism. The work channels of the gas distribution mechanism or the sleeves 6 have been positioned side by side on the same plane that is set at angle a of the axis of the cylinder. On FIG. 3 the relative positions of the cylinder sleeve 2, intake channel 7, plug 8 and exhaust channel 13 can be seen. The block head with slide valve gear is suitable for any engine.

The operating system of the piston valves is launched by a processor that is controlled through all parameters of the engine. The construction of the engine brought in the invention allows solving the problem of using different engine fuels. The piston valves 12 have the capability of inward pumping since the piston itself will raise the level of pressure so that the engine can operate besides gasoline also on gas, spirit and solid fuel. In case of direct injection into the cylinder the engine can operate on kerosene and diesel fuel. Normal operation of the engine with different fuels is facilitated by adjusting the ignition angle and pressure level. As and example a solution has been brought with the phases of gas distribution in a 4-stroke gasoline engine that corresponds to the invention.

Intake phase: The intake channel 7 is opened 8° before the top dead center (TDC). At the same time the exhaust channel 13 is closed. Fresh fuel mix enters the cylinder 2 through intake channel 7 and sleeve 6 of the gas distribution mechanism that is positioned at a 40-50% angle of the cylinder axis, the fuel mix collides against the wall of the cylinder 2 and acquires spiral motion as well as heats, at the same time washing the walls of the cylinder.

Compression phase: 49° after the bottom dead center (BDC) the intake channel 7 is closed. The fuel mix is compressed.

Combustion phase: 6° before TDC ignition is performed. Since the fuel mix will maintain spiral motion during combustion it is combusted in a shorter time than in a valve engine. Ignition is accelerated by using a circular side electrode on plugs 8.

Exhaust phase: 30° before-the BDC the exhaust channel 13 is opened. The fuel mix will rapidly exit in a spiral motion and the cycle is concluded.

1. An internal combustion engine that is comprised of block head housing (1), at least one cylinder (2), piston (3), ignition plug (8), combustion chamber (5), sleeves (6) of gas distribution mechanism, intake and exhaust channels (7, 13) whereas the intake channel (7) and the exhaust channel (13) are connected with the corresponding sleeve (6) of the gas distribution mechanism, the gas distribution mechanism sleeves (6) are positioned at an equal angle of the axis of the cylinder and on the same plane, characterized in that the mentioned plane is at a 40-50° angle of the axis of the cylinder (2).
